(19) United States
(12) Patent Application Publication
(10) Pub. No.: US 2011/0291861 A1
(43) Pub. Date: Dec. 1, 2011

(54) Device for Communication with an Aircraft

(75) Inventors: Hugues MEUNIER, Frouzins (FR); Nicolas ROSSI, Toulouse (FR)

(73) Assignee: THALES, Neuilly-sur-Seine (FR)

(21) Appl. No.: 13/118,130

(22) Filed: May 27, 2011

(30) Foreign Application Priority Data
Jun. 1, 2010 (FR) FR1002308

(51) Int. Cl. G08B 21/00

(52) U.S. Cl. 340/945

(57) ABSTRACT

A device for assisting in understanding the traffic surrounding an aircraft during communications between aircraft with one or more ground control organizations performed via a digital data link set up on a frequency, each of the control organizations communicating and exchanging digital messages with a plurality of aircraft on said frequency, includes: reception means for the aircraft to receive the messages exchanged between the aircraft and the ground control organization on said frequency, means for storing the messages received by the aircraft and means for displaying all or some of the received messages.

### CROSS-REFERENCE TO RELATED APPLICATION

This application claims priority to foreign French patent application No. FR 1002308, filed on Jun. 1, 2010, the disclosure of which is incorporated by reference in its entirety.

### FIELD OF THE INVENTION

The invention relates to the field of aeronautical communications and, more particularly, the communications between ground controllers and aircraft.

### BACKGROUND

According to the prior art, the communications between an aircraft and the ground controllers, called ATC standing for Air Traffic Control, are conducted orally by radio link. Each of the aircraft listening to a frequency receives all the communications exchanged by the ATC and the other aircraft. FIGS. 1a and 1b respectively illustrate uplink and downlink communications between an aircraft and a ground controller according to the prior art. The uplink communications (from the ground controller 100 to the aircraft 101) and downlink communications (from the aircraft 101 to the ground controller 100) are performed in broadcast mode and are accessible to other aircraft 102, 103, the identification of the receiving entity being contained in the oral message.

Provision is made for these oral communications between aircraft and ATC to be replaced by communications via dedicated digital data link. This has the advantage of minimizing the interpretation errors inherent in the misunderstandings of ATC messages received vocally. FIG. 1c illustrates uplink and downlink communications between an aircraft and a ground controller via data link. The communication is set up only between the aircraft 101 and the ground controller 100, the other aircraft 102, 103 no longer having access to these communications.

By using a digital data link, only the communications involving the aircraft are displayed on an onboard screen, for example a dedicated device such as a DCDU. FIG. 2 shows an exemplary display of messages received by data link according to the prior art. This display comprises a window 200 for displaying a single message which contains the frequency used (1022Z), the sender of the message (from LFBO App) and the message itself (CLIMB FL080). The display also comprises two buttons MSG+ amd MSG− for scrolling the messages in the window 200, a PRINT button for optionally printing the displayed message on a printer on board the aircraft, an NOK button to enable the crew to reject the instruction given by ground control, an STBY button to enable the crew to signal that it has indeed received the message but is not able to satisfy the instruction given by ground control in the short term (STBY=US abbreviation for “standby”), and a WILCO button to enable the crew to confirm to ground control that it will satisfy the given instruction (WILCO=US abbreviation for “will comply”).

However, without knowing the messages exchanged between ATC and the other aircraft in its environment, the knowledge of only the ATC messages intended for its aircraft (without the knowledge of the messages exchanged between these other aircraft and a control organization) does not provide the crew with a mental vision of the position and/or trajectory situation of their aircraft with respect to the other aircraft. Such an understanding of the environment is often useful to the crew, even if the tasks of separation are the responsibility of ATC. In fact, the information (typically the intentions and trajectory modifications of the surrounding aircraft) obtained in this way is particularly useful for such an understanding. An example worth citing is the knowledge of the level that will be reached by another aircraft upon a change of level or the knowledge of a route diversion for weather reasons. Such an understanding will be all the more necessary when the concepts envisaged for the “self-separation” (independent separation at aircraft level without interaction with control) SESAR or NextGen programs are developed and implemented.

Already known from the U.S. Pat. No. 6,160,497 is a system embedded on board an aircraft that makes it possible to associate the communications of surrounding aircraft with the situation of this surrounding traffic visualized on an onboard screen of TCAS (Traffic Alert and Collision Avoidance System) type. For such an association, this system presents the drawback of correlating the messages sent by the surrounding aircraft based on their position, involving: 1) the addition of an instantaneous position information item concerning the sender in each of the messages transmitted by the various aeroplanes or control centres, requiring all the existing aeroplanes to modify the current communication means to enable this position information to be sent, 2) and defining the positions of the surrounding aircraft based on a system for signalling the risks of collision with other aircraft (called TCAS), the positions of these aircraft then being only determined relatively in relation to the aircraft, such a position information item concerning the various aircraft displayed not moreover being available other than for display without modifying all of these TCAS systems on the existing aeroplanes.

### SUMMARY OF THE INVENTION

The invention aims to overcome the abovementioned problems induced by the transition to digital communications, by proposing a device for the communication of an aircraft with controllers situated on the ground via a data link. The aim of the invention is to provide assistance to the crew of an aircraft by improving, in the aircraft cockpit, the understanding of the traffic situation around the aircraft when the latter and other aircraft in its environment are communicating with air traffic control via one and the same digital data link.

To this end, the subject of the invention is a device for the communication of an aircraft with a control organization situated on the ground via a digital data link set up on a frequency, the organization on the ground communicating and exchanging messages with a plurality of aircraft on said frequency, the device being characterized in that it comprises:
reception means (301) for the aircraft to receive the messages exchanged between the aircraft and the organization on the ground on said frequency,
means for storing (302) the messages received by the aircraft,
means for displaying (303) at least one of the received messages and exchanged between one of the other aircraft or the organization on the ground.

The invention enables the pilot to have an understanding of the position and of the intentions of the other aircraft according to the instructions received from ATC.

The storage of the messages provides a log which lightens the workload of the pilots who no longer have to listen in real time to the various communications. The pilots can read them at their request according to the log attached to one or more aircraft of interest.

The replacement of oral communications with data link communications enables the crew to better understand the ATC messages that are addressed to it. On the other hand, the crew loses the knowledge of the other aeroplanes in its environment and their intentions. Even though it is not the job of the pilots to be responsible for the strategic monitoring of the other aeroplanes (tactical avoidance of collisions remaining under the responsibility of the crew), this does increase flight safety, the pilots thus being prepared to take into account sudden instructions from control, even to mitigate any control defects.

The invention provides for an enhanced display of all the ATC messages, not only for its own aircraft but also, and primarily, for the aircraft in its vicinity with selection modes based on scrolling lists, and, in a preferred embodiment, an interaction with traffic displays showing the surrounding aircraft, such a display being provided, for example, through a device conventionally called “Traffic Computer”.

The use of an ADS-B-type link also makes it possible to retrieve the absolute position, the identification of the surrounding aircraft, this position comprising the altitude of the aircraft unlike the positions determined using a TCAS in the state of the art cited. These identifications of the surrounding aeroplanes make it possible to correlate the messages transmitted by the surrounding aeroplanes with the aircraft situated in the near environment of the aircraft. This solution is not achievable with the means disclosed in the prior art because the TCAS system does not make it possible to obtain the identifications of the surrounding aeroplanes on the basis of which the correlation proposed here is performed.

### BRIEF DESCRIPTION OF THE DRAWINGS

The invention will be better understood and other advantages will become apparent from reading the detailed description, given as a nonlimiting example, and with the help of the figures, in which:

FIGS. 1a and 1b, already described, respectively illustrate uplink and downlink communications in oral form between an aircraft and a ground controller according to the prior art.

FIG. 1c, already described, illustrates uplink and downlink communications between an aircraft and a ground controller by data link.

FIG. 2 shows an exemplary display of messages received by data link according to the prior art.

FIG. 3 shows a first exemplary implementation of the device according to the invention.

FIG. 4 shows an exemplary display of messages with a scrolling list.

FIG. 5 shows a second exemplary implementation of the device according to the invention.

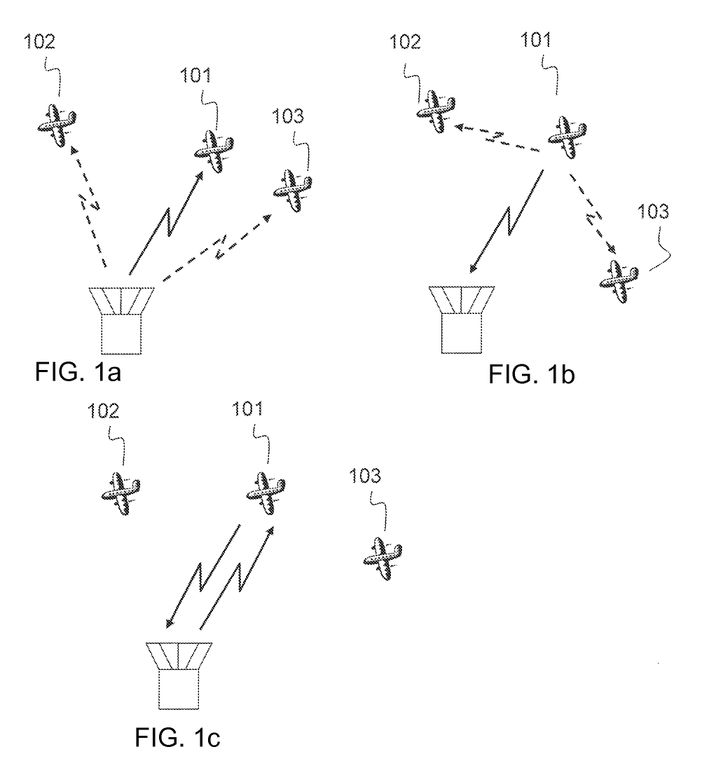

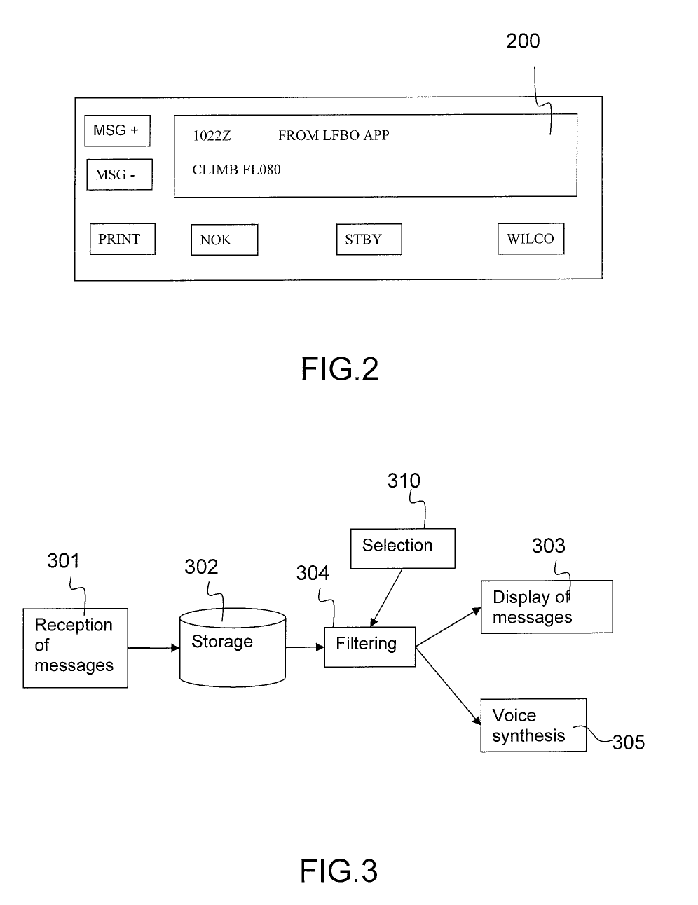

### DETAILED DESCRIPTION

The device according to the invention allows the communication between an aircraft and a control organization situated on the ground via a digital data link set up on a frequency. The control organization communicates with a plurality of aircraft on the same frequency.

FIG. 3 shows an exemplary implementation of the device according to the invention. The device comprises reception means 301 for the aircraft to receive messages exchanged between the aircraft and the control organization on said frequency, means for storing 302 the messages received by the aircraft, and means for displaying 303 at least one of the received messages. The messages displayed are those exchanged between the other aircraft and the organization on the ground.

The reception means 301 comprise, for example, a VHF radio. The means for storing 302 the messages received by the aircraft are implemented, for example, in a communications router such as a CMU or an ATSU that is capable of decoding the identifier of the aircraft for which the message is intended.

As an example, it is possible to cite the uplink messages of ACARS type which notably include the following information: a flight identifier comprising two letters identifying the airline and four digits representing the flight number (for example AF 3210) or an address enabling the aircraft to be identified.

In the most recent aircraft, including multifunction screens implementing windowing concepts, the received messages are displayed in a dedicated window.

The means for storing the messages make it possible to provide, in the cockpit, a log of past communications.

Advantageously, the means for displaying 303 the received messages include a scrolling list making it possible to display a plurality of messages. The scrolling list displays, for example, the last 10 messages exchanged.

In the case of digital communications, a message contains, in digital form, a time of sending, a designation of a sender and a designation of a recipient. In the case of a message from the ground to an aircraft, called uplink channel, the sender is a ground control organization and the recipient an aircraft. In the case of a message from an aircraft to the ground, called downlink channel, the sender is an aircraft and the recipient a ground control organization. Thus, a message always contains a designation of an aircraft and of a ground control organization.

According to one feature of the invention, the device according to the invention also comprises means for selecting 310 a criterion and means 304 for filtering the stored received messages according to the selected criterion, the criterion being chosen from: the time of sending of the message, the designated aircraft or the ground control organization designated in the message, the means for displaying 303 the received messages displaying only the messages that correspond to the selected criterion.

For example, if the pilot selects an identifier of an aircraft, then the means for displaying the messages display only the messages concerning that aircraft.

Similarly, the selection criterion may relate only to a ground control organization. The pilot of the aircraft can thus know, through these messages, the problems involving the airport associated with this control organization.

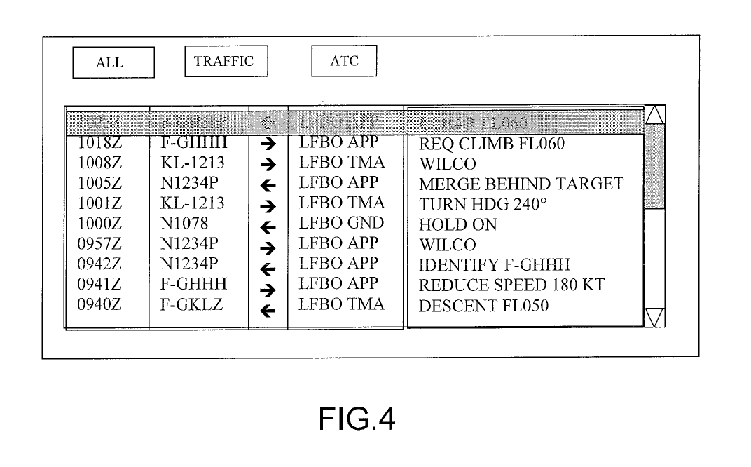

FIG. 4 shows an exemplary display of messages with a scrolling list. The display comprises a table with five columns. Each column of the table corresponds to an uplink or downlink message. A first column indicates the frequency used, the second column indicates an identifier of an aircraft, a third column indicates whether the message is uplink or downlink (for example by arrows), a fourth column indicates a ground control organization and a fifth column indicates the text of the message. In general, there is only one control organization on one and the same frequency, but the example is shown in the case where the reception means comprise a simultaneous multichannel radio. In this example, the last message is boxed and underlined as long as it is current.

A press on a scroll box (dedicated button or designatable screen) makes it possible to scroll the messages.

The display comprises a “TRAFFIC” button for selecting and displaying only the messages involving a particular aircraft, for example the one for which the code is displayed on the 1st line.

The display also includes an “ATC” button for selecting and displaying only the messages involving a particular ATC centre, for example the one whose code is displayed on the 1st line.

The display also includes an “ALL” button for displaying all the messages in chronological order.

The messages involving his own aircraft may be displayed or not, said messages being already available on a DCDU.

Advantageously, the communication device according to the invention also comprises means for voice synthesizing 305 the received messages.

The received messages are communicated to the crew in voice form at the time of their reception. This communication is provided in addition to or instead of the inscription on the display means. As for the display, all the stored messages previously exchanged, or a preselected subset, can be communicated to the crew in voice form.

Advantageously, the aircraft comprises means for displaying the aircraft 306 situated in the near environment of said aircraft. The communication device according to the invention also comprises means 307 for correlating the received messages with the displayed aircraft and for signalling whether a received message involves one of the displayed aircraft.

The display of the surrounding aircraft is usually called CDTI for Cockpit Display of Traffic Information. The identification and the geographic positions of the surrounding aircraft are obtained via a link of ADS-B (in) type. The positions obtained are absolute positions and comprise a latitude, a longitude and an altitude.

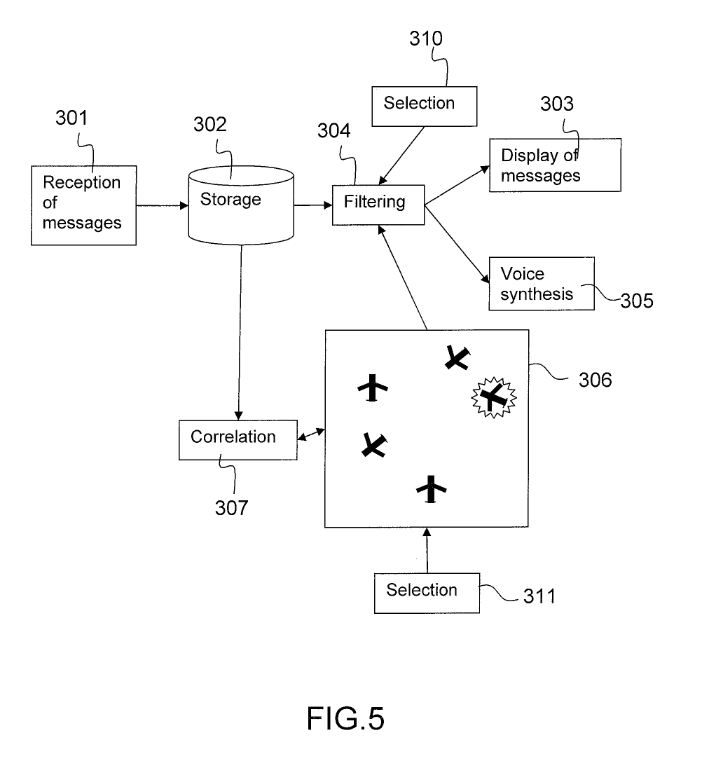

FIG. 5 shows a second exemplary implementation of the device according to the invention. This exemplary implementation has the same features as the first exemplary implementation but with the addition of the means for displaying the aircraft 306 situated in the near environment of said aircraft and means for correlating 307 the received messages with the displayed aircraft and for signalling whether a received message involves one of the displayed aircraft.

To signal whether a received message involves one of the displayed aircraft, the device provides an indication of the aircraft concerned to the crew such as, for example, blinking of the symbol of the aircraft designated in the message or modification of the colour of this symbol.

Advantageously, the device also comprises means for selecting 311 an aircraft from the displayed aircraft, the selected aircraft being used as filtering criterion for the means for filtering messages.

Based on these means for selecting a particular aircraft on a CDTI screen such as, for example, a channel selector switch switching from one traffic to another, the invention makes it possible to display only the messages exchanged with the selected aeroplane and the ATC. This display can take place:
(i) as and when the messages are received, thus enabling the crew to follow in real time the exchanges between the selected aeroplane and the ATC, or
(ii) in the form of a log, in a scrolling list of the latest messages in which it is possible to navigate, then enabling the crew to improve its knowledge of the situation with regard to this aircraft by reviewing the latest exchanges.

Display of the aircraft involved in a message and the selection of an aircraft in order to monitor its exchanges (or to know the log of its latest exchanges) thus makes it possible to significantly increase the knowledge of a crew with respect to its environment.

Advantageously, the device also comprises means for receiving messages exchanged between the aircraft and ground control on a plurality of frequencies. In this case, the reception means comprise, for example, a simultaneous multichannel radio.

1. A device for the communication of an aircraft, with a control organization situated on the ground, via a digital data link set up on a frequency, the organization on the ground communicating and exchanging messages with a plurality of aircraft on said frequency, comprising:
reception means for the aircraft to receive the messages exchanged between the aircraft and the organization on the ground on said frequency, each of the messages including an identifier of an aircraft for which the message is intended,
means for storing the messages received by the aircraft,
means for displaying at least one of the received messages and exchanged between one of the other aircraft or the organization on the ground,
means for displaying the aircraft situated in the environment close to said aircraft, and
means for correlating the received messages with the aircraft displayed and for signalling if a received message is intended for one of the displayed aircraft, the identifiers of the aircraft being obtained by messages transmitted by an ADS-B-type link.

2. The device for communication according to claim 1, wherein the means for displaying the received messages include a scrolling list making it possible to display a plurality of messages.

3. The device for communication according to claim 1, wherein, a message also including a time of sending and a designation of a control organization, the device also comprises means for selecting a criterion and means for filtering the stored received messages according to the selected criterion, said criterion being chosen from: the time of sending, the designated aircraft or the ground control organization designated in the message, the means for displaying the received messages displaying only the messages corresponding to the selected criterion.

4. The device for communication according to claim 1, further comprising means for voice synthesizing the received messages.

5. The device for communication according to claim 3, further comprising means for selecting an aircraft from the displayed aircraft, the selected aircraft being used as filtering criterion by the means for filtering the messages.

6. The device for communication according to claim 1, further comprising means for receiving the messages exchanged between the aircraft and the ground control on a plurality of frequencies.
